(19) United States
(12) Patent Application Publication
(10) Pub. No.: US 2009/0119359 A1
(43) Pub. Date: May 7, 2009

(54) Server, computerized network including same, and method for increasing level of efficiency of a network

(75) Inventor: Alon Cohen, Modiin (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: Cyber-Ark Software Ltd., Petach Tikva, IL (US)

(21) Appl. No.: 10/599,402

(22) PCT Filed: Mar. 29, 2005
(86) PCT No.: PCT/IL2005/000354

§ 371 Date: Sep. 28, 2006

Related U.S. Application Data
(60) Provisional application No. 60/556,886, filed on Mar. 29, 2004.

(51) Int. Cl. G06F 15/16

(52) U.S. Cl. 709/203

(57) ABSTRACT

A data access engine 22, computerized system 20 and method 40 for increasing a level of efficiency of a network server are disclosed. Data access engine 22 located in first data processing machine 21 is capable of communication with at least one pseudo server 28 located in a second data processing machine 27 (i.e. LAN server 26). The physical separation between data access engine 22 and the server logic and interface of pseudo server 28 is a distinguishing characteristic of the invention. Any request for a subset of data stored in data access engine 22 must be routed through at least one pseudo server 28.

### FIELD AND BACKGROUND OF THE INVENTION

The present invention relates to an improved server and, more particularly, to a server in which the data access engine is separated from the server logic and interface. The invention further relates to computerized networks including the improved server, and methods for increasing a level of efficiency of a network via use of the improved sender.

Security in terms of both data integrity and privacy is a major concern for all computerized systems. Every modem computerized system has security “holes” which are susceptible to attack. Widening access to the system increases vulnerability to attack.

Most computers today are in communication with either a local area network (LAN) or a Wide area network (WAN) or the Internet or a combination thereof. The Internet, while it offers many advantages, has inherent problems including a low level of security, low level of performance and limited communication protocols.

The Internet is a slow infrastructure. Retrieval of data across the Internet often results in unsatisfactory performance. Typically, a firewall is placed between a LAN and the Internet to improve the security of the LAN. However, this usually blocks many communication protocols (e.g. CIFS; FTP/S; RPC) and prevents the use of most of the advanced tools typically available within the LAN.

In today's business world, it is often necessary to collaborate with other people using computers that belong to a different LAN (e.g. suppliers, subcontractors, collaborators etc.). Typically, these interactions take place by sharing servers between several LANs across the Internet.

This prevents use of internal directory definitions, network login or single sign on. The net result is the inconvenience of administrating user accounts from several LANs on one server and/or reduced security.

One way to facilitate exchange of data among user clients is to implement servers for “shared” material. A typical server 0 (FIG. 1) according to known configurations includes server logic and interface 3. This represents approximately 90% of the code and imparts server functionality. This males it complex. Portion 3 of the code interacts with the User and may vary from one version to another. As a result of its size and, complexity, the frequent changes and the interaction with the users, it is susceptible to attacks of various types. Currently available server 0 also includes a data access engine 5 which contains about 10% of the code and is responsible for data storage and retrieval. This portion is typically fixed and interacts with the data as opposed to users, data access engine 5 is characterized by a simple and closed architecture. As a result, data access engine 5 is less susceptible to attack (i.e. unauthorized access or manipulation) than server logic and interface 3.

There is thus a widely recognized need for, and it would be highly advantageous to have, an improved server, computerized network including same, and method for increasing a level of efficiency of a network devoid of the above limitations.

### SUMMARY OF THE INVENTION

According to one aspect of the present invention there is provided a data access engine. The data access engine is located in a first data processing machine and capable of communication with at least one pseudo server located in a second data processing machine. Any request for a subset of data stored in the data access engine must be routed through the at least one pseudo server.

The term “pseudo server” as used in this specification and the accompanying claims refers to a module which contains only the server logic and user interface, and which is separated from the corresponding data access engine.

The term “data access engine” as used in this specification and the accompanying claims refers to a module which contains only the part of the code which handles data access requests and the corresponding data, and does not contain the server logic and user interface.

The term “LAN” as used in this specification and the accompanying claims refers to a local area network.

The term “WAN” as used in this specification and the accompanying claims refers to a wide area network.

The term “Internet” as used in this specification and the accompanying claims refers to the World Wide Web (WWW).

According to another aspect of the present invention there is provided a computerized network. The network includes: (a) a data access engine located in a first data processing machine and capable of communication with at least one pseudo lo server; (b) the at least one pseudo server located in a second data processing machine. Any request for a subset of data stored in the data access engine must be routed through the at least one pseudo server.

According to yet another aspect of the present invention there is provided a method for increasing a level of efficiency of a network server. The method includes: (a) installing a data access engine in a first data processing machine, the data access engine capable of communication with at least one pseudo server; (b) further installing the at least one pseudo server in a second data processing machine; (c) permitting communication between the data access engine and the pseudo server; (d) requiring that a request for a subset of data stored in the data access engine must be routed through the at least one pseudo server; (e) honoring the request if it is routed through the pseudo server; and (f) denying the request if it is not routed through the pseudo server.

According to further features in preferred embodiments of the invention described below, the second data processing machine resides within a LAN in which the data access engine resides.

According to still further features in the described preferred embodiments the second data processing machine resides outside of a LAN in which the data access engine resides.

According to still further features in the described preferred embodiments the communication occurs across a content filtering device deployed between the data access engine and the pseudo server.

According to still further features in the described preferred embodiments the at least one pseudo server includes at least two pseudo servers.

According to still further features in tile described preferred embodiments retrieval of data by the data access engine is further restricted by network vaults.

According to still further features in the described preferred embodiments a request received by the at least one pseudo server must originate within a LAN in which the second data processing machine resides.

According to still further features in the described preferred embodiments the method further includes implementing network vaults within the data access engine.

The present invention successfully addresses the shortcomings of the presently known configurations by providing an increased level of protection for data stored is outside of a LAN.

Alternately, or additionally, the present invention successfully addresses the shortcomings of the presently known configurations by providing an increased level of protection for data stored within a LAN and accessible to users outside the LAN.

Implementation of the method and system of the present invention involves performing or completing selected tasks or steps manually, automatically, or a combination thereof. Moreover, according to actual instrumentation and equipment of preferred embodiments of the method and system of the present invention, several selected steps could be implemented by hardware of by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a graphic representation of a conventional computerized server.

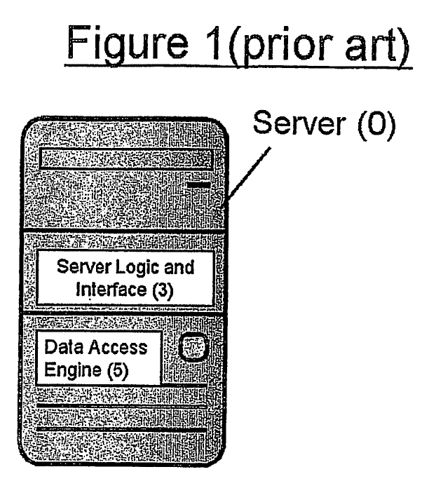

FIG. 2 is a diagram of a system according to various embodiments of the present invention.

FIG. 3 is a simplified flow diagram of a method according to the present invention.

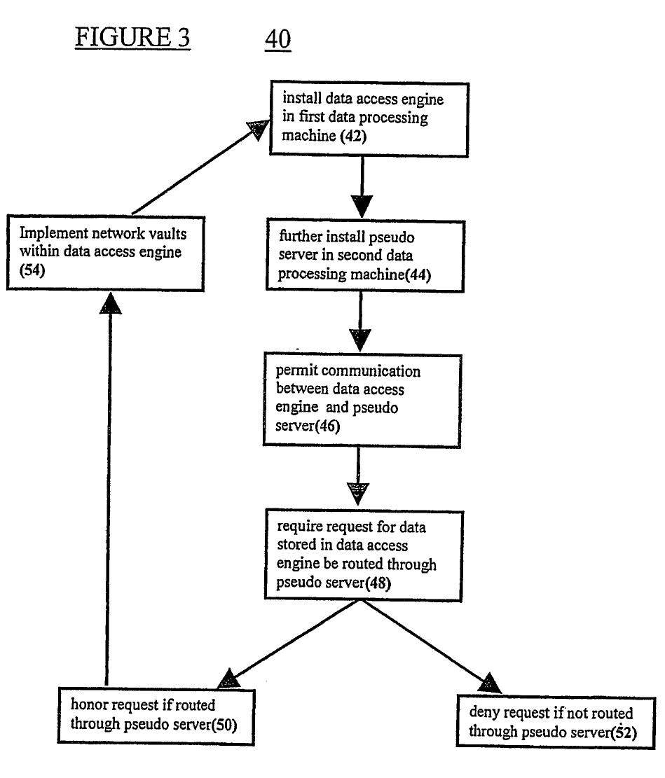

### DESCRIPTION OF THE PREFERRED EMBODIMENTS

The present invention is of an improved server which can be employed to improve network performance. The invention further relates to computerized networks including the improved server, and methods for increasing a level of efficiency of a network via use of the improved server.

Specifically, the invention is of a server in which the data access engine is separated from the server logic and interface. According to the invention, the server logic and interface are deployed separately as a “pseudo server”.

The present invention makes access to stored in the data access engine simpler, faster and more efficient by permitting users to communicate with a server logic and interface that is closer to them than in previously available network configurations. In addition, the invention enhances data accessibility by providing an enhanced set of data communication protocols which could not previously be implemented in a WAN or the Internet. Further, the present invention streamlines and simplifies the administrative aspects of establishing and maintaining a shared server Preferably, the server is an inter site server as detailed hereinbelow.

Specifically, the present invention can be used to assure security while increasing communication efficiency. In other words, the present invention increases security of stored data while increasing system performance and user accessibility. These benefits result from separation of the server data access engine from the corresponding server logic and interface.

The principles and operation of an improved server according to the present invention may be better understood with reference to the drawings and accompanying descriptions.

Before explaining at least one embodiment of the invention in detail, it is to be understood that the invention is not limited in its application to the details of is construction and the arrangement of the components set forth in the following description or illustrated in the drawings. The invention is capable of other embodiments or of being practiced or carried out in various ways. Also, it is to be understood that the phraseology and technology employed herein is for the purpose of description and should not be regarded as limiting.

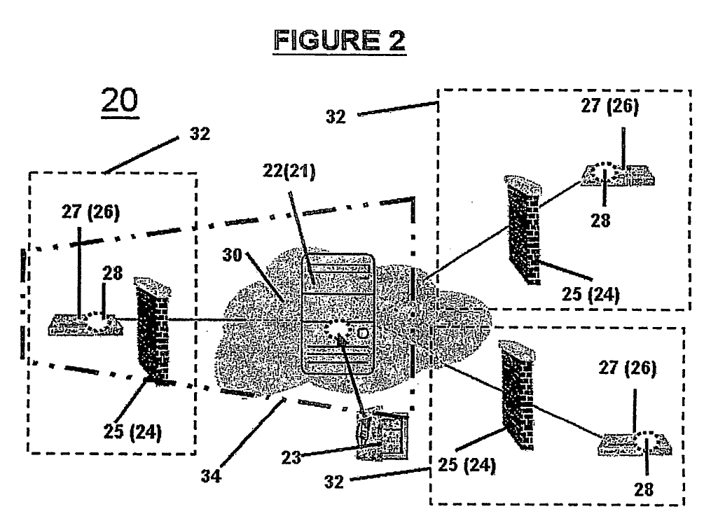

Referring now to FIG. 2, the present invention is embodied by a data access engine 22 (as defined hereinabove) located in first data processing machine 21. Data access engine 22 is capable of communication with at least one pseudo server 28 (as defined hereinabove) located in a second data processing machine 27 (i.e. LAN server 26). In FIG. 2, three pseudo servers 28 are pictured, although more might actually be employed. The physical separation between data access engine 22 and the server logic and interface of pseudo server 28 is a distinguishing characteristic of the invention. Any request for a subset of data stored in data access engine 22 must be routed through at least one pseudo server 28.

The present invention is further embodied by a computerized network 20 including a data access engine 22 located in first data processing machine 21 and capable of communication with pseudo server 28 located in second data processing machine 27. Any request for a subset of data stored in data access engine 22 must be routed through a pseudo server 28.

As a result, sharing of data among LANs 32 with an unprecedented degree of ease and security is achieved. Users operating user clients (not pictured) within LAN 32 interact with a user interface, preferably a graphical user interface (GUT) of pseudo server 28 installed locally on LAN server 26. This allows rapid response in formulation of queries or requests directed to the GUT. This represents a significant improvement with respect to prior art alternatives where all interact was with a remote lo server logic interface 3 located on a conventional server 0, typically available to LAN 32 via a connection to Internet 30. Only requests for data are routed to data access engine 22 located in first data processing machine 21, for example one located outside of all LANs 32, on Internet 30.

According to some preferred embodiments of system 20, second data processing machine 27 resides within a LAN 34 (indicated by bold dotted trapezoid) in which data access engine 22 resides.

According to alternate preferred embodiments of system 20, second data processing machine 27 resides outside of a LAN 32 in which the data access engine 22 resides.

According to further alternate preferred embodiments of system 20 data access engine 22 is installed on first data processing machine 21 on Internet 30 and is not included in any LAN 32.

Optionally, but preferably, communication between data access engine 22 and pseudo server 28 occurs across a content filtering device 25 (e.g. firewall 24) deployed between data access engine 22 and pseudo server 28. Device 25 serves to protect pseudo server 28 from unauthorized requests and or attempts at data manipulation (i.e. “hacking” activity).

Although a system 20 with one pseudo server 28 is within the scope of the claimed invention, systems 20 with two, or more preferably three or more pseudo servers 28 are preferred. Such systems 20 increase the magnitude of the improvements offered by the invention. Thus, at least one pseudo server 28 preferably includes at least two pseudo servers 28.

Optionally, but preferably, retrieval of data by data access engine 22 is further restricted by network vaults 23 implemented in first data processing machine 21 as disclosed in U.S. Pat. No. 6,356,941. One of ordinary skill in the art of systems operation will be able to incorporate the teachings of U.S. Pat. No. 6,356,941 into the context of tie present invention.

The present invention is further embodied by a method 40 for increasing a level of efficiency of a network server. Method 40 includes installing 42 data access engine in 22(as detailed hereinabove) in first data processing machine 21.

Method 40 further includes installing 44 at least one pseudo server 28 in second data processing machine 27.

Method 40 further includes permitting 46 communication between the data access engine 22 and pseudo server 28. Communication is in the form of requests from is pseudo server 28 for data from first data processing machine 21, preferably from vault 23. Requests are implemented by data access engine 22.

Method 40 further includes requiring 48 that a request for a subset of data stored in data access engine 22 must be routed through a pseudo server 28.

According to method 40 a request is honored 50 if it is routed through a pseudo server 28 and denied 52 if it is not routed through the pseudo server.

Method 40 preferably includes implementation 54 of network vaults 23 as detailed hereinabove.

Thus, honoring 50 a request results in retrieval of data from vault 23 and transmission thereof to a user client via pseudo server 28.

Optionally, but preferably, a request received by pseudo server 28 must originate within a LAN 32 in which second data processing machine 27 resides.

In other words, system 20 permits a user of a first pseudo server 28 to share content with a user of a second pseudo server 28 by placing the content in storage (e.g. vault 23) accessible to shared remote data access engine 22. This sharing is accomplished without compromising security of the content.

It is important to function of system 20 that the Interface portion of the server is close to the user (i.e. in Pseudo server 28) and only the shared remote Data Access engine 22 is “on the Internet”. This configuration solves most of today's security, performance, accessibility and administrative problems.

Optionally, but preferably, fireballs 24 are deployed between Local pseudo servers 28 and Internet 30.

Most preferably retrieval of data by shared remote data access engine 22 is further restricted by network vaults as taught by U.S. Pat. No. 6,356,941.

As a result, the “Hackable” server interface 28 is safely housed within a LAN 32 where it is protected by firewall 24. This configuration allows individual users, operating user clients (not pictured) capable of communication with different pseudo servers 28 to share data across Internet 30 with a degree of security previously achieved only within a single LAN 32.

In addition, this sharing allows remote implementation of caching, compression and clustering because pseudo server 28 is close to user client(s) within LAN 32. As a result, improved system performance and increased data security are achieved contemporaneously.

In addition, since each pseudo server 28 is located within a LAN 32 and no fireball 34 is deployed between any of pseudo servers 28 and user clients within a LAN 32, every user client in the three LANs 32 pictured may use communication protocols such as CIFS, FTP/S and RPC because requests for data are not impeded by firewalls 24. This arrangement allows sharing of content which would previously have been deemed a security risk.

An additional benefit of system 20 is that each pseudo server 28 determines how much bandwidth they require and supplies it accordingly. This places the burden of bandwidth purchase on data users, as opposed to data suppliers.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. AR publications, patents and patent applications mentioned in this specification are herein incorporated in their entirety by reference lo into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A data access engine, said data access engine located in a first data processing machine and capable of communication with at least one pseudo server located in a second data processing machine;
wherein a request for a subset of data stored in the data access engine must be routed through said at least one pseudo server.

2. The data access engine of claim 1, wherein said second data processing lo machine resides within a LAN in which the data access engine resides.

3. The data access engine of claim 1, wherein said second data processing machine resides outside of a LAN in which the data access engine resides.

4. The data access engine of claim 1, wherein said communication occurs across a content filtering device deployed between the data access engine and said pseudo server.

5. The data access engine of claim 1, wherein said at least one pseudo server includes at least two pseudo servers.

6. The data access engine of claim 1, wherein retrieval of data by the data access engine is further restricted by network vaults.

7. A computerized network, the network comprising:
(a) a data access engine located in a first data processing machine and capable of communication with at least one pseudo server;
(b) said at least one pseudo server located in a second data processing machine;
wherein a request for a subset of data stored in the data access engine must be routed through said at least one pseudo server.

8. The computerized network of claim 6, wherein said second data processing machine resides within a LAN in which said data access engine resides.

9. The computerized network of claim 6, wherein said second data processing machine resides outside of a LAN in which said data access engine resides.

10. The computerized network of claim 7, wherein said communication occurs across a content filtering device deployed between said data access engine and said pseudo server.

11. The computerized network of claim 7, wherein said at least one pseudo server includes at least two pseudo servers.

12. The computerized network of claim 7, wherein retrieval of data by the data access engine is further restricted by network vaults.

13. The computerized network of claim 7, wherein a request received by said at least one pseudo server must originate within a LAN in which said second data processing machine resides.

14. A method for increasing a level of efficiency of a network server, the method comprising:
(a) installing a data access engine in a first data processing machine, said data access engine capable of communication with at least one pseudo server;
(b) further installing said at least one pseudo server in a second data processing machine;
(c) permitting communication between said data access engine and said pseudo server;
(d) requiring that a request for a subset of data stored in the data access engine must be routed through said at least one pseudo server;
(e) honoring said request if it is routed through said pseudo server; and
(f) denying said request if it is not routed through said pseudo server.

15. The method of claim 14, wherein said second data processing machine resides within a LAN in which said data access engine resides.

16. The method of claim 14, wherein said second data processing machine resides outside of a LAN in which said data access engine resides.

17. The method of claim 12, wherein said communication occurs across a content filtering device deployed between said data access engine and said pseudo server.

18. The method of claim 12, wherein said at least one pseudo server includes at least two pseudo servers.

19. The method of claim 12, further comprising implementing network vaults within said data access engine.

20. The method of claim 12, wherein a request received by said at least one pseudo server must originate within a LAN in which said second data processing machine resides.
